(19) United States
(12) Patent Application Publication
(10) Pub. No.: US 2014/0195556 A1
(43) Pub. Date: Jul. 10, 2014

(54) Calories Tracking When Making Mobile Payment Through Near Field Communications

(71) Applicant: Yang-Cheng Fan, San Jose, CA (US)

(72) Inventor: Yang-Cheng Fan, San Jose, CA (US)

(73) Assignee: SAP AG, Walldorf (DE)

(21) Appl. No.: 13/738,695

(22) Filed: Jan. 10, 2013

(51) Int. Cl. G06F 17/30

(52) U.S. Cl. CPC G06F 17/30312
USPC 707/769

(57) ABSTRACT

A system, a method, and a computer program product for tracking of attributes, such as calories, vitamins, minerals, fat, and the like, of a food item when purchasing the food item from a point of sale location are disclosed. Information representative of a plurality of food items purchased from at least one point of sale location is received by the user's equipment from a terminal at a point of sale location via a near field communications medium. The information includes an identification of the plurality of food items and identification of at least one attribute associated with each food item in the plurality of food items. The user's equipment obtains numerical values of at least one attribute associated with each purchased food item in the plurality of food items from a database that stores numerical values of at least one attribute. User's equipment determines a total value of numerical values of at least one attribute associated with a plurality of purchased food items by summing the numerical values during a predetermined period of time. The total value and the values of the attributes can be displayed by the user's equipment.

### TECHNICAL FIELD

This disclosure relates generally to data processing and, in particular, to tracking of attributes, such as calories, vitamins, minerals, fat, and the like, of a food item when purchasing the food item from a point of sale location.

### BACKGROUND

In today's world, food can come from a variety of sources and can contain varying nutritional content, including naturally occurring ingredients, additives, and/or preservatives. Food can also be characterized by the quantity of calories, content of vitamins and minerals, and other components. Some individuals may consider some foods to be healthier than other foods based on the components in these food items and thus, structure their diets accordingly. Given the vast variety of nutritional choices, proper diet may play an important role in maintaining individual's health. Some dietary choices may reduce development of chronic diseases, weight gain, or other negative effects on a person while improving longevity and overall quality of life. Other dietary choices may have opposite effects. The overall diet may be determined by a series of individual selections that may be based on the components associated with or contained in a particular food item.

### SUMMARY

In some implementations, the current subject matter relates to a computer-implemented method for tracking of attributes, such as calories, vitamins, minerals, fat, and the like, of a food item when purchasing the food item from a point of sale location. The method can include receiving, by a user's equipment, information representative of a plurality of food items purchased from at least one point of sale location, the information including an identification of the plurality of food items and identification of at least one attribute associated with each food item in the plurality of food items, the user's equipment receiving the information from at least one terminal associated with the at least one point of sale location via a near field communications medium, obtaining, by the user's equipment, numerical values of at least one attribute associated with each purchased food item in the plurality of food items, wherein, to obtain the numerical values of at least one attribute, the user's equipment communicates with a database storing the numerical values of at least one attribute, determining, by the user's equipment, a total value of numerical values of at least one attribute associated with a plurality of purchased food items by summing the numerical values, wherein the total value is determined during a predetermined period of time, and displaying, by the user's equipment, the obtained numerical values of at least one attribute and the total value associated with the plurality of purchased food items.

In some implementations, the current subject matter can include one or more of the following optional features. The food items can be purchased using a near field communications medium. At least one attribute associated with the food item can include at least one of the following: a calorie, a nutrient to limit consumption of, a nutrient to increase consumption of, and food ingredients, and the numerical value of the at least one attribute is a number corresponding to an amount of the at least one attribute associated with the food item. The database can be stored in a memory that includes at least of the following: a memory of the user's equipment, a memory location at the point of sale and a remote memory location.

In some implementations, the method can include determining whether the total numerical value exceeds a predetermined threshold value and generating an alert when the total numerical value exceeds the predetermined threshold value. The predetermined threshold value can be predetermined by a user consuming the plurality of food items and corresponds to a total value associated with all food items consumed by the user during a predetermined period of time.

In some implementations, the predetermined period of time can include at least one of the following: a day, a week, a month, a year, a plurality of days, a plurality of weeks, a plurality of months, a plurality of years, and various combinations thereof.

In some implementations, the method can include determining, using user's equipment, numerical values of at least one attribute based on an attribute category associated with the at least one attribute and displaying, on the user's equipment, the total value of the numerical values based on the attribute category.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system for tracking of attributes of a food item when purchasing a food item at a point of sale location, according to some implementations of the current subject matter;

FIG. 2 illustrates an exemplary food item attribute counting report for purchased food items, according to some implementations of the current subject matter;

FIG. 3 illustrates an exemplary system, according to some implementations of the current subject matter; and

FIG. 4 illustrates an exemplary method, according to some implementations of the current subject matter.

### DETAILED DESCRIPTION

Frequently, food is purchased by a consumer without an identification of the content, caloric content, nutritional information, and the like of the food. For example, food items may be purchased from sources, such as cafés, restaurants, diners, and the like, that do not typically list content. To make matters worse, these facilities may prepare their food items differently from one another. Thus, a consumer purchasing a particular food item may be completely unaware of the food item's particular content. Hence, it may be difficult for the consumer to decide whether or not to purchase the food item. This may lead to misguided dietary choices.

To address the above-noted and potentially other deficiencies of currently available solutions, one or more implementations of the current subject matter provide methods, systems, articles or manufacture, and the like that can, among other possible advantages, provide systems and methods for providing systems, methods, and computer program products for tracking various attributes of a food item when purchasing the food item at a point of sale location.

In some implementations, the current subject matter relates to a system and a method for tracking information about, or attributes of, a food item being purchased by an individual during a particular period of time. The food item can be purchased at a café, a restaurant, a dining facility, a grocery store, and/or any other point of sale location and/or facility (hereinafter, referred to as a “point of sale location”). The point of sale location can provide a selection of different food items (whether raw or prepared) for purchase by a user. It can also provide a way for the user to purchase particular food item(s) through the use of a conventional point of sale terminal (either attended by a cashier and/or self-serviced), where the user can provide a payment for the selected food item(s) to the point of sale terminal and after payment be able to carry away the purchased food item(s). The payment can be provided in the form of cash, credit cards, coupons, electronic payments, as well as in any other way. The user can use the user's cellular telephone, smartphone, tablet computer, laptop computer, portable digital assistant device, and/or any other device to pay for the selected food item(s). Payment can also be accomplished through the use of wireless, such as Bluetooth, Bluetooth low energy, near field communications (“NFC”), and other like low energy wireless access technologies, In the case of low energy wireless, such as NFC, it can allow communications between two endpoints, such as a point of sale terminal and user's cellular telephone, for the purposes of providing payment for the selected food item(s). Other forms and/or methods of payment can be used to pay for the selected food item.

In some implementations, the food item can be a food item containing a single item (e.g., bread, meat, milk, etc.) or a plurality of items (e.g., a sandwich that contains bread, meat, lettuce, tomatoes, etc.). The food items can also be provided with a label indicating what the food item is and what type of ingredients and/or components it includes (e.g., a number calories, vitamins, minerals, carbohydrates, fats, etc.). The food item can be identified (e.g., a ham and cheese sandwich) or can be unlabeled, so as not to include any information as to what types of ingredients/components it includes.

In some implementations, the user purchasing food item(s) at a particular point of sale location can select food items available at that point of sale location and proceed to purchase them at the location's point of sale terminal. The point of sale terminal can be used to enter (e.g., scan, if the items have an appropriate identification information, such as a barcode or radio frequency identification information) the information about the food item, including what the food item is and its corresponding price. Based on the entered information, the current subject matter system can determine what the attributes of the food item are, including calories, vitamins, minerals, carbohydrates, fats, etc. The system can then obtain numerical values corresponding to each identified attribute associated with the food item. The system can determine the attributes as well as obtain numerical values using a database or a table that can contain information about attributes and corresponding numerical values associated with the food item. The database/table can be stored in a memory that can be located at the point of sale location and/or at a remote location. The point of sale terminal can be communicatively coupled to the database and can request appropriate information based on a receipt of information about a food item that is being selected by the user. In some implementations, the user's payment device (such as a user's cellular telephone, smartphone, tablet computer, laptop computer, portable digital assistant device, and/or any other device) can store the database/table and/or be communicatively coupled to the memory location storing the database/table.

After obtaining the numerical values of the food item's attributes, the current subject matter system can generate a total value for each attribute contained in the food item and generate a report. In some implementations, the current subject matter system can compute total values for all similar attributes (e.g., calories) for all food items that the user purchased during a predetermined period of time (e.g., a day, a week, a month, a year, and/or any other time period). The determination can be performed by the point of sale location and/or by the user's device. Then, the user can be presented with a total value for each attribute for all food items purchased (and/or consumed) during a predetermined period of time.

In some implementations, the current subject matter system can also alert the user about the food items that the user purchased and/or contemplating about purchasing and indicate that if the user purchases a particular food item, such purchase will cause the total value of a particular attribute for the food items purchased during a predetermined period of time to exceed a predetermined threshold value. The threshold value can be determined by the user and/or by the current subject matter system. For example, the system can generate an alert on the user's device when a total number of calories corresponding to all food items that the user purchased within a day exceeds 2000 calories. The user may use the alert accordingly.

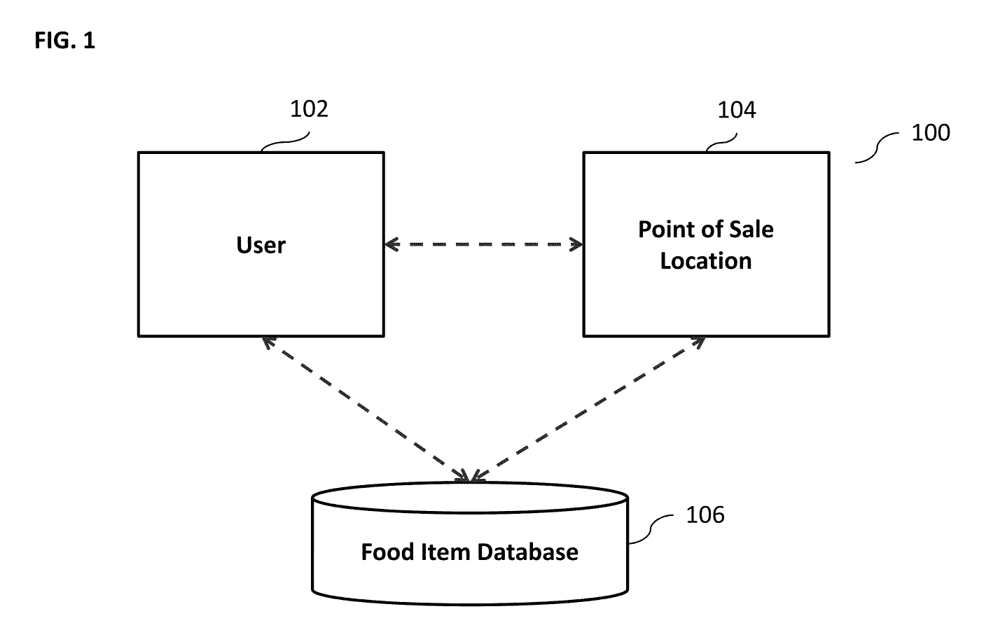

FIG. 1 illustrates an exemplary system 100 for tracking information about food items, according to some implementations of the current subject matter.

The system 100 can include a user 102, a point of sale location 104, and a food item database 106. The user 102 can be a user desiring to select and purchase at least one food item from the point of sale location 104. The user can use a user device to purchase the food item, where the device can include at least one of the following: user's cellular telephone, smartphone, and/or any other wireless processor-based device.

The point of sale location 104 can provide a variety of different food items and/or combination of food items available for selection/purchasing by the user. The point of sale location 104 can also include a plurality of point of sale terminals that can allow the user 102 to purchase the selected food items using user's device. As discussed above, the food items can be identified and can contain a plurality of attributes having numerical values.

The database 106 can contain information about food items that are available at the point of sale location 104. The information can include identification of food items and their associated attributes along with corresponding numerical values for each attribute found in the food item. In some implementations, the database 106 can be communicatively coupled to the point of sale location 104 and/or the user's device of the user 102. The database 106 can be stored in a memory that can be located at the point of sale location 104 or remotely from the point of sale location 104. Alternatively, the database 106 can be stored on the user's device. The database 106 can also contain information about food items that may be specific to a particular point of sale location 104. This can allow the user 102 to differentiate between food items (even if they are identical) that can be made available by each point of sale location 104. For example, a cheeseburger available for selection/purchase from restaurant A may have 500 calories, whereas a cheeseburger available for selection/purchase from restaurant B may have 350 calories. This information can be included in the database 106, which may lead the user 102 to purchase the cheeseburger from restaurant B.

In some implementations, the database 106 is implemented as an in-memory database. The in-memory database is implemented in memory (e.g., dynamic random access memory, Flash memory, and the like), rather than mechanical memory devices, such as hard-drives, optical drives and the like. The use of the in-memory database may, in some implementations, reduce the time required to obtain the information from database 106.

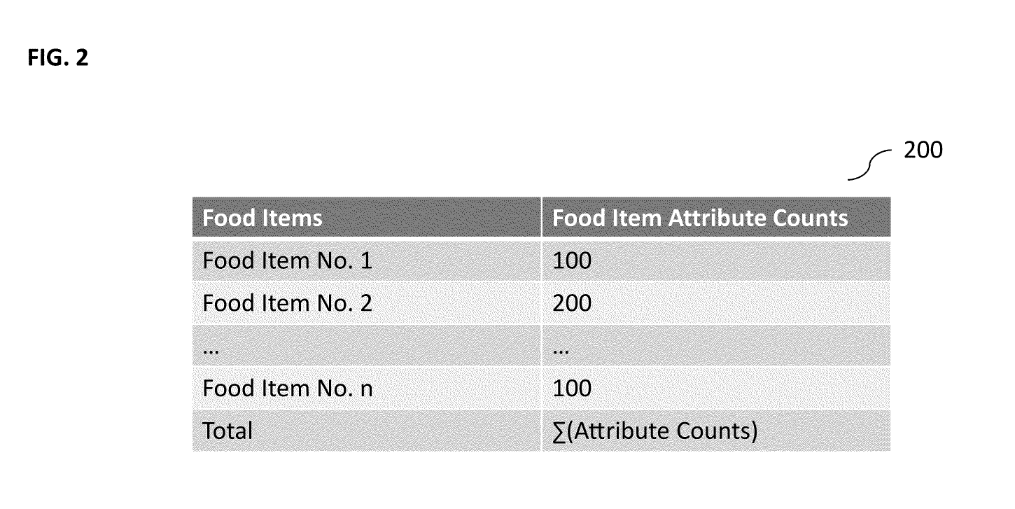

As stated above, upon selection/purchasing of a food item, the system 100 can determine specific attributes of the food item and obtain corresponding numerical values from the database 106. The system can then determine the total numerical value for each attribute (or for a user-selected attribute) of the food item. After determination of the total numerical value, the user 102 can be provided with a report indicating what the numerical values of each attribute are as well as what the total numerical value of the attributes in the food item is. The report can be provided on the user's device. An exemplary report 200 identifying an attribute (e.g., calories, vitamins, fats, minerals, etc.) count (e.g., 10 calories, 20 mg of Vitamin C) in a food item (which can be a combination of food items nos. 1, 2, . . . , n) is shown in FIG. 2, where the total number of attributes is a sum of the attribute counts in each food item nos. 1, 2, . . . , n. The user can be provided with such report for a specific attribute of a food item and/or all food items that the user may have purchased during a predetermined period of time (e.g., a day, a week, a month, a year, and/or any other time period). The report can include information broken down by a specific attribute, i.e., one for calories, one for food ingredients to avoid (e.g., fats, sodium, etc.), one for food ingredients to get more of (e.g., vitamins, protein, etc.), and one for other ingredients (e.g., magnesium, riboflavin, etc.) The system 100 can also provide the user with an alert if the total numerical value exceeds a predetermined threshold value, which can be preset by the user, the system, and/or in any other fashion.

In some implementations, the current subject matter can track information about food items being purchased in various attribute categories. Some exemplary categories can include at least one of the following: calories, nutrients to limit (e.g., saturated fat, trans fat, cholesterol, sodium, etc.), nutrients to get enough of (e.g., vitamins, iron, calcium), and/or other ingredients. In some implementations, the current subject matter can also track information about specific constituents in the food, e.g., calories, calories from fat, fat, saturated fat, trans fat, cholesterol, sodium, carbohydrates, dietary fiber, sugars, protein, vitamin A, vitamin C, vitamin D, vitamin E, vitamin K, vitamin B6, vitamin B12, calcium, iron, thiamin, riboflavin, niacin, folate, biotin, pantothenic acid, phosphorus, iodine, magnesium, zinc, selenium, copper, manganese, chromium, molybdenum, and/or chloride. The current subject matter can also provide the user with an ability to track information about a specific food constituent category and specific items within that category. For example, in the category of “nutrients to limit”, the user can track information about total fat being consumed by the user as can be indicated by a number of grams of fat for a particular food item as well as a total number of grams of fat for all items purchased during a period of time. The user can also be provided with an information that indicates how many grams of fat, the user may have already consumed and how many she/he will consume as a result of purchasing and eating the purchased food item in relation to a recommended daily allowance of fat. The recommended daily allowances for each food constituent can be obtained based on recommendations of U.S. Food and Drug Administration and/or any other organization, agency, etc.

The user can also be provided with various status updates relating to specific constituents of food that the user may be consuming. These status updates can be in the form of charts, tables, graphs that show how much of a particular food constituent the user is consuming, has consumed or is about to consume. The system can also provide the user with information about past food consumption based on a particular period of time (e.g., daily, weekly, monthly, yearly, etc.). The user can also set various consumption goals (e.g., consume 100 mg of vitamin C each day) and receive alerts indicative of whether the user already reach the goal, what is required to reach the goal (e.g., the user's goal is consume 100 mg of vitamin C per day, the user already consumed 50 mg of vitamin C today, and hence needs another 50 mg to reach the goal). The system can also recommend food items to the user that may help the user to reach user's consumption goal (e.g., the user's consumption goal is 100 mg of Vitamin C per day, the user consumed 50 mg of Vitamin C already, and thus, needs another 50 mg of Vitamin C, thus, the user can be advised that consumption of an orange will fulfill the user's consumption goal for daily Vitamin C intake).

The status updates, notifications, alerts, and/or any other information can be displayed on the user's cellular telephone, smartphone, tablet computer, laptop computer, portable digital assistant device, and/or any other wireless processor-based device.

In some implementations, the current subject matter system can provide the user with a way to track information about user's food purchases and/or potential consumption, thereby allowing the user to control the food intake during a predetermined period of time. Therefore, the current subject matter system provides an effective way for the user to ascertain and control user's dietary habits, needs, and/or desires.

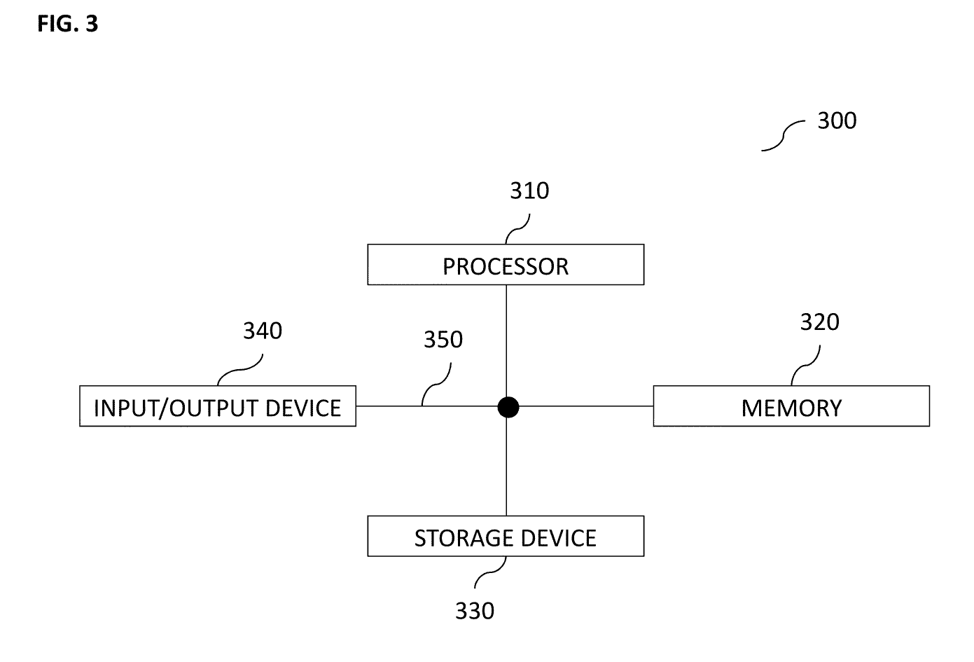

In some implementations, the current subject matter can be configured to be implemented in a system 300, as shown in FIG. 3. The system 300 can include a processor 310, a memory 320, a storage device 330, and an input/output device 340. Each of the components 310, 320, 330 and 340 can be interconnected using a system bus 350. The processor 310 can be configured to process instructions for execution within the system 300. In some implementations, the processor 310 can be a single-threaded processor. In alternate implementations, the processor 310 can be a multi-threaded processor. The processor 310 can be further configured to process instructions stored in the memory 320 or on the storage device 330, including receiving or sending information through the input/output device 340. The memory 320 can store information within the system 300. In some implementations, the memory 320 can be a computer-readable medium. In alternate implementations, the memory 320 can be a volatile memory unit. In yet some implementations, the memory 320 can be a non-volatile memory unit. The storage device 330 can be capable of providing mass storage for the system 300. In some implementations, the storage device 330 can be a computer-readable medium. In alternate implementations, the storage device 330 can be a floppy disk device, a hard disk device, an optical disk device, a tape device, non-volatile solid state memory, or any other type of storage device. The input/output device 340 can be configured to provide input/output operations for the system 300. In some implementations, the input/output device 340 can include a keyboard and/or pointing device. In alternate implementations, the input/output device 340 can include a display unit for displaying graphical user interfaces.

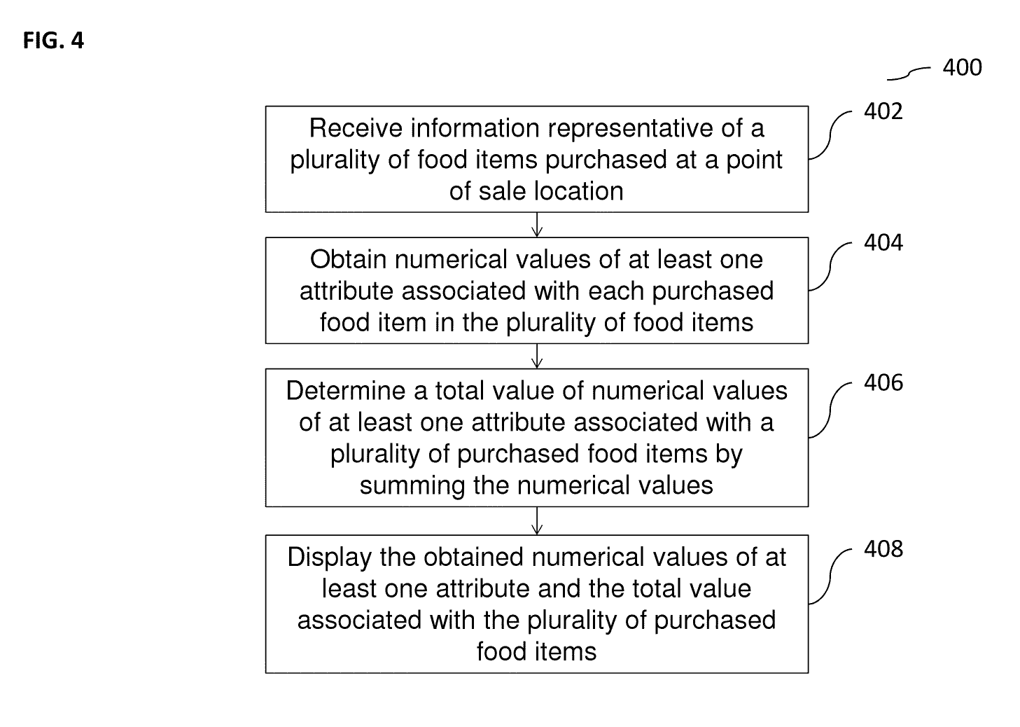

FIG. 4 illustrates an exemplary method 400, according to some implementations of the current subject matter.

At 402, information about a plurality of food items purchased at a point of sale location can be received by the user's equipment, such as a cellular telephone, smartphone, tablet computer, laptop computer, portable digital assistant device, and/or any other wireless processor-based device. The user equipment can operate using a near field communication's medium to receive information from the product's label. The user's equipment can receive the information from at least one terminal associated with the at least one point of sale location via a near field communications medium. For example, when the user selects a food item for purchasing (at a café, grocery store, etc.), the food item can be scanned using a point-of-sale terminal (which may include a portable or stationary scanning equipment, a cash register, and/or any other known devices associated with point-of-sale terminals) to determine what the food item is. Upon scanning, the point-of-sale terminal can communicate information about the food item to the user's equipment. The communicated information can be an indication of what the food item is (e.g., ham and cheese sandwich), food item's content (i.e., food item attributes (e.g., 300 calories, 10 g of fat, etc.)), pricing, etc. Alternatively, the communicated information can include only the information identifying the food item (e.g., ham and cheese sandwich). In some implementations, the user and/or cashier attending the point-of-sale terminal can manually enter information about the food item either at the point-of-sale terminal and/or directly on the user's equipment, which can include identification of the food item, food item attributes (which, for example, may be ascertained from a nutrition label), price, etc.

At 404, numerical values of at least one attribute associated with each purchased food item in the plurality of food items can be obtained. Upon identification of the food item, information about food item's attributes can be received by the user's equipment. This information can be communicated to the user's equipment by the point-of-sale terminal, which can obtain this information from a database (either local or remote to the point-of-sale terminal). Alternatively, the user's equipment, upon receiving the identification information about the food item, can send a query to a database that contains information about the identified food item to determine food item's attributes. The user's equipment can communicate with the database directly and/or via the point-of-sale equipment and/or any other device. The information that is received by the user's equipment can include all information about content of the food item or specific information that the user may have requested (e.g., calorie content, vitamin content, fat content, etc.). For example, for a ham and cheese sandwich that the user selected, the user's equipment can receive the following attribute values: 300 calories, 5 grams of fat, 2% calcium, etc.

At 406, a total value associated with a plurality of purchased food items can be determined based on the numerical values associated with each purchased food item. The user's equipment can perform various calculations in relation to many different food items that the user may have purchased at a particular location and/or different locations. The calculations can be performed during a specific period of time (e.g., on a daily basis, on a weekly basis, on a monthly basis, etc.). For example, the user may wish to find out how many calories the user consumed during a day and how the user's consumption compares to a particular calorie threshold value (which can be set by the user, based on various governmental regulations (e.g., by Food and Drug Administration), and/or in any other fashion). For example, during a day the user has consumed an egg and cheese omelet for breakfast, a turkey and cheese sandwich for lunch, and a steak for dinner. Each consumed item may have a specific calorie value associated with it, e.g., an egg and cheese omelet—200 calories, turkey and cheese sandwich—300 calories, and steak—1000 calories. Thus, the user's equipment can add the above three calorie values for the three items and determine that the user consumed 1500 calories during that day. The user's equipment can determine values for all food items consumed by the user and/or specific food items identified by the user. The user's equipment can also compare the calculated value to a particular threshold (e.g., 2000 calorie per day) and determine whether or not the user exceeded the threshold, what is required to reach the threshold, recommend what the user may consume to reach the threshold, etc. The user's equipment can also generate various alerts based on this comparison.

Further, the user's equipment can also track information about food items using various attribute categories, which can include at least one of the following: calories, nutrients to limit (e.g., saturated fat, trans fat, cholesterol, sodium, etc.), nutrients to get enough of (e.g., vitamins, iron, calcium), and/or other ingredients. Within each category, the user's equipment can provide information to the user about values of a specific attribute in relation to the food item that is being consumed by the user.

At 408, the obtained numerical values of at least one attribute and the total value associated with the plurality of purchased food items can be displayed on the user's device.

In some implementations, the user's equipment can also provide management capabilities to the user. In addition to providing user with an ability to track information about attributes of the food items, the user's equipment can assist the user with payment for the selected food items (e.g., sending payment to the point-of-sale terminal using user's credit card information, bank account information, wire transfer, etc.), maintaining a predetermined spending budget for the food items (e.g., $50 per day for purchasing of food items), tracking user's expenditures on food items during a predetermined period of time, tracking information about user's expenditures on food items in relation to particular food attribute (e.g., user spent $500 per month purchasing high calorie food items), etc.

In some implementations, the current subject matter can include at least one of the following optional features. Purchasing of the food item can be performed using a near field communications medium. At least one attribute associated with the food item can include at least one of the following: a calorie, a nutrient to limit consumption of, a nutrient to increase consumption of, and food ingredients. The numerical value of the at least one attribute can include an amount of the at least one attribute associated with the food item. The determination of total value associated with the plurality of purchased food items can include obtaining the numerical value from at least one database, wherein the database is stored in a memory located that includes at least of the following: a memory location at the point of sale and a remote memory location.

In some implementations, the method can also include determining whether the total numerical value exceeds a predetermined threshold value and generating an alert when the total numerical value exceeds the predetermined threshold value. The predetermined threshold value can be predetermined by a user consuming the plurality of food items and can correspond to a total value associated with all food items consumed by the user during a predetermined period of time.

In some implementations, the predetermined period of time can include at least one of the following: a day, a week, a month, a year, a plurality of days, a plurality of weeks, a plurality of months, a plurality of years, and various combinations thereof.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
receiving, by a user's equipment, information representative of a plurality of food items purchased from at least one point of sale location, the information including an identification of the plurality of food items and identification of at least one attribute associated with each food item in the plurality of food items, the user's equipment receiving the information from at least one terminal associated with the at least one point of sale location via a near field communications medium;
obtaining, by the user's equipment, numerical values of at least one attribute associated with each purchased food item in the plurality of food items, wherein, to obtain the numerical values of at least one attribute, the user's equipment communicates with a database storing the numerical values of at least one attribute;
determining, by the user's equipment, a total value of numerical values of at least one attribute associated with a plurality of purchased food items by summing the numerical values, wherein the total value is determined during a predetermined period of time; and
displaying, by the user's equipment, the obtained numerical values of at least one attribute and the total value associated with the plurality of purchased food items.

2. The method according to claim 1, wherein the food items are purchased using a near field communications medium.

3. The method according to claim 1, wherein the at least one attribute associated with the food item includes at least one of the following: a calorie, a nutrient to limit consumption of, a nutrient to increase consumption of, and food ingredients, and the numerical value of the at least one attribute is a number corresponding to an amount of the at least one attribute associated with the food item.

4. The method according to claim 1, wherein the database is stored in a memory that includes at least of the following: a memory of the user's equipment, a memory location at the point of sale and a remote memory location.

5. The method according to claim 1, further comprising
determining whether the total numerical value exceeds a predetermined threshold value; and
generating an alert when the total numerical value exceeds the predetermined threshold value.

6. The method according to claim 5, wherein the predetermined threshold value is predetermined by a user consuming the plurality of food items and corresponds to a total value associated with all food items consumed by the user during a predetermined period of time.

7. The method according to claim 1, wherein the predetermined period of time includes at least one of the following: a day, a week, a month, a year, a plurality of days, a plurality of weeks, a plurality of months, a plurality of years, and various combinations thereof.

8. The method according to claim 1, further comprising
determining, using user's equipment, numerical values of at least one attribute based on an attribute category associated with the at least one attribute; and
displaying, on the user's equipment, the total value of the numerical values based on the attribute category.

9. A computer program product comprising a machine-readable medium storing instructions that, when executed by at least one programmable processor, cause the at least one programmable processor to perform operations comprising:
receiving, by a user's equipment, information representative of a plurality of food items purchased from at least one point of sale location, the information including an identification of the plurality of food items and identification of at least one attribute associated with each food item in the plurality of food items, the user's equipment receiving the information from at least one terminal associated with the at least one point of sale location via a near field communications medium;
obtaining, by the user's equipment, numerical values of at least one attribute associated with each purchased food item in the plurality of food items, wherein, to obtain the numerical values of at least one attribute, the user's equipment communicates with a database storing the numerical values of at least one attribute;
determining, by the user's equipment, a total value of numerical values of at least one attribute associated with a plurality of purchased food items by summing the numerical values, wherein the total value is determined during a predetermined period of time; and
displaying, by the user's equipment, the obtained numerical values of at least one attribute and the total value associated with the plurality of purchased food items.

10. The computer program product according to claim 9, wherein the food items are purchased using a near field communications medium.

11. The computer program product according to claim 9, wherein the at least one attribute associated with the food item includes at least one of the following: a calorie, a nutrient to limit consumption of, a nutrient to increase consumption of, and food ingredients, and the numerical value of the at least one attribute is a number corresponding to an amount of the at least one attribute associated with the food item.

12. The computer program product according to claim 9, wherein the database is stored in a memory that includes at least of the following: a memory of the user's equipment, a memory location at the point of sale and a remote memory location.

13. The computer program product according to claim 9, wherein the operations further comprise
determining whether the total numerical value exceeds a predetermined threshold value; and
generating an alert when the total numerical value exceeds the predetermined threshold value.

14. The computer program product according to claim 13, wherein the predetermined threshold value is predetermined by a user consuming the plurality of food items and corresponds to a total value associated with all food items consumed by the user during a predetermined period of time.

15. The computer program product according to claim 9, wherein the predetermined period of time includes at least one of the following: a day, a week, a month, a year, a plurality of days, a plurality of weeks, a plurality of months, a plurality of years, and various combinations thereof.

16. The computer program product according to claim 9, wherein the operations further comprise
determining, using user's equipment, numerical values of at least one attribute based on an attribute category associated with the at least one attribute; and
displaying, on the user's equipment, the total value of the numerical values based on the attribute category.

17. A system comprising:
at least one programmable processor; and
a machine-readable medium storing instructions that, when executed by the at least one programmable processor, cause the at least one programmable processor to perform operations comprising:
receiving, by a user's equipment, information representative of a plurality of food items purchased from at least one point of sale location, the information including an identification of the plurality of food items and identification of at least one attribute associated with each food item in the plurality of food items, the user's equipment receiving the information from at least one terminal associated with the at least one point of sale location via a near field communications medium;
obtaining, by the user's equipment, numerical values of at least one attribute associated with each purchased food item in the plurality of food items, wherein, to obtain the numerical values of at least one attribute, the user's equipment communicates with a database storing the numerical values of at least one attribute;
determining, by the user's equipment, a total value of numerical values of at least one attribute associated with a plurality of purchased food items by summing the numerical values, wherein the total value is determined during a predetermined period of time; and
displaying, by the user's equipment, the obtained numerical values of at least one attribute and the total value associated with the plurality of purchased food items.

18. The system according to claim 16, wherein the at least one attribute associated with the food item includes at least one of the following: a calorie, a nutrient to limit consumption of, a nutrient to increase consumption of, and food ingredients, and the numerical value of the at least one attribute is a number corresponding to an amount of the at least one attribute associated with the food item.

19. The system according to claim 16, wherein the operations further comprise
determining whether the total numerical value exceeds a predetermined threshold value; and
generating an alert when the total numerical value exceeds the predetermined threshold value;
wherein the predetermined threshold value is predetermined by a user consuming the plurality of food items and corresponds to a total value associated with all food items consumed by the user during a predetermined period of time.

20. The system according to claim 16, wherein the operations further comprise
determining, using user's equipment, numerical values of at least one attribute based on an attribute category associated with the at least one attribute; and
displaying, on the user's equipment, the total value of the numerical values based on the attribute category.
